(19) United States
(12) Patent Application Publication
(10) Pub. No.: US 2007/0135952 A1
(43) Pub. Date: Jun. 14, 2007

(54) Audio channel extraction using inter-channel amplitude spectra

(75) Inventor: Pavel Chubarev, Novosibirsk (RU)

Correspondence Address: DTS, INC., 5171 CLARETON DRIVE, AGOURA HILLS, CA, 91301, US

(73) Assignee: DTS, Inc.

(21) Appl. No.: 11/296,730

(22) Filed: Dec. 6, 2005

(51) Int. Cl. G06F 17/00

(52) U.S. Cl. 700/94

(57) ABSTRACT

Inter-channel amplitude spectra are used to extract multiple audio channels from two or more audio input channels comprising a mix of audio sources. This approach produces multiple audio channels that are not merely linear combinations of the input channels, and thus can than be used, for example, in combination with a blind source separation (BSS) algorithm.

### BACKGROUND OF THE INVENTION

1. Field of the Invention

This invention relates to the extraction of multiple audio channels from two or more audio input channels comprising a mix of audio sources, and more particularly to the use of inter-channel amplitude spectra to perform the extraction.

2. Description of the Related Art

Blind source separation (BSS) is a class of methods that are used extensively in areas where one needs to estimate individual original audio sources from stereo channels that carry a linear mixture of the individual sources. The difficulty in separating the individual original sources from their linear mixtures is that in many practical applications little is known about the original signals or the way they are mixed. In order to do demixing blindly some assumptions on the statistical nature of signals are typically made.

Independent Component Analysis (ICA) is one method, perhaps the most widely used for performing blind source separation. ICA assumes that the audio sources are statistically independent and have nongaussian distributions. In addition, the number of audio input channels must be at least as large as the number of audio sources to be separated. Furthermore, the input channels must be linearly independent; not linear combinations of themselves. In other words, if the goal is to extract, for example, three or perhaps four audio sources such as voice, string, percussion, etc from a stereo mix, forming a third or fourth channel as a linear combination of the left and right channels would not suffice. The ICA algorithm is well known in the art and is described by Aapo Hyvarinen and Erkki Oja, “Independent Component Analysis: Algorithms and Applications”, Neural Networks, April 1999, which is hereby incorporated by reference.

Unfortunately in many real world situations only a stereo mix is available. This severely limits BSS algorithms based on ICA to separating at most two audio sources from the mix. In many applications, audio mixing and playback is moving away from conventional stereo to multi-channel audio having 5.1, 6.1 or even higher channel configurations. There is a great demand to be able to remix the vast catalog of stereo music for multi-channel audio. To do so effectively, it will often be highly preferable if not necessary to separate three or more sources from the stereo mix. Current ICA techniques cannot support this.

### SUMMARY OF THE INVENTION

The following is a summary of the invention in order to provide a basic understanding of some aspects of the invention. This summary is not intended to identify key or critical elements of the invention or to delineate the scope of the invention. Its sole purpose is to present some concepts of the invention in a simplified form as a prelude to the more detailed description and the defining claims that are presented later.

The present invention provides a method for extracting multiple audio output channels from two or more audio input channels that are not merely linear combinations of those input channels. Such output channels can than be used, for example, in combination with a blind source separation (BSS) algorithm that requires at least as many linearly independent input channels as sources to be separated or directly for remixing applications, e.g. 2.0 to 5.1.

This is accomplished by creating at least one inter-channel amplitude spectra for respective pairs of M framed audio input channels that carry a mix of audio sources. These amplitude spectra may, for example, represent the linear, log or norm differences or summation of the pairs of input spectra. Each spectral line of the inter-channel amplitude spectra is then mapped into one of N defined outputs, suitably in an M−1 dimensional channel extraction space. The data from the M input channels are combined according to the spectral mappings to form N audio output channels. In an embodiment, the input spectra are combined according to the mapping and the combined spectra are inverse transformed and the frames recombined to form the N audio output channels. In another embodiment, a convolution filter is constructed for each of the N outputs using the corresponding spectral map. The input channels are passed through the N filters and recombined to form the N audio output channels.

These and other features and advantages of the invention will be apparent to those skilled in the art from the following detailed description of preferred embodiments, taken together with the accompanying drawings, in which:

### BRIEF DESCRIPTION OF THE DRAWINGS

FIG. 1 is a block diagram including a channel extractor and source separator for separating multiple audio sources from an audio mix;

FIG. 2 is a block diagram for extracting additional audio channels using inter-channel amplitude spectra in accordance with the present invention;

FIGS. 3a through 3c are diagrams depicting various mappings from the inter-channel amplitude spectra to a channel extraction space;

FIG. 4 is a block diagram of an exemplary embodiment for extracting three output channels from a stereo mix using spectral synthesis of the input channels in accordance with the spectral mapping;

FIGS. 5a through 5c are diagrams illustrating windowing an audio channel to form a sequence of input audio frames;

FIG. 6 is a plot of the frequency spectra of the stereo audio signals;

FIG. 7 is a plot of the difference spectrum;

FIG. 8 is a table illustrating two different approaches to combining the input spectra;

FIGS. 9a through 9c are plots of the combined spectra for the three output audio channels;

FIG. 10 is a block diagram of an alternate embodiment using a convolution filter to perform time-domain synthesis of the input channels in accordance with the spectral mapping.

### DETAILED DESCRIPTION OF THE INVENTION

The present invention provides a method for extracting multiple audio channels from two or more audio input channels comprising a mix of audio sources, and more particularly to the use of inter-channel amplitude spectra to perform the extraction. This approach produces multiple audio channels that are not merely linear combinations of the input channels, and thus can then be used, for example, in combination with a blind source separation (BSS) algorithm or to provide additional channels directly for various re-mixing applications.

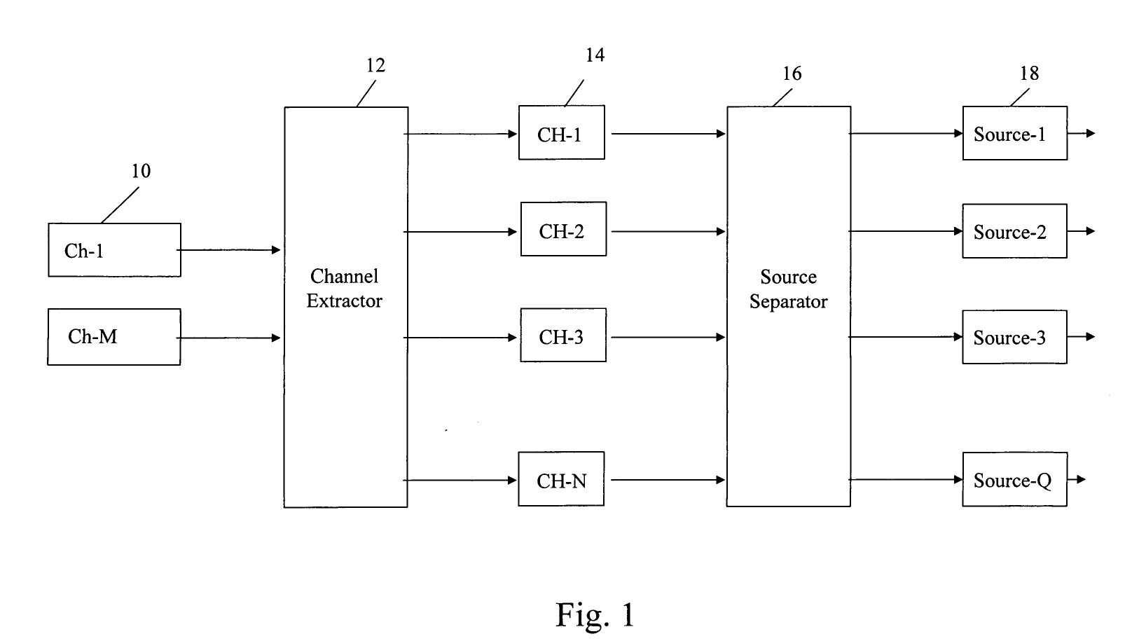

As an exemplary embodiment only, the extraction technique will be described in the context of its use with a BSS algorithm. As described above, for a BSS algorithm to extract Q original audio sources from a mixture of those sources it must receive as input at least Q linearly independent audio channels that carry the mix. As shown in FIG. 1, the M audio input channels 10 are input to a channel extractor 12, which in accordance with the present invention uses inter-channel amplitude spectra of the input channels to generate N>M audio output channels 14. A source separator 16 implements a BSS algorithm based on ICA to separate Q original audio sources 18 from the N audio output channels where Q≦N. For example, when used together the channel extractor and source separator can extract three, four or more audio sources from a conventional stereo mix. This will find great application in the remixing of the music catalog that only exists now in stereo into multi-channel configurations.

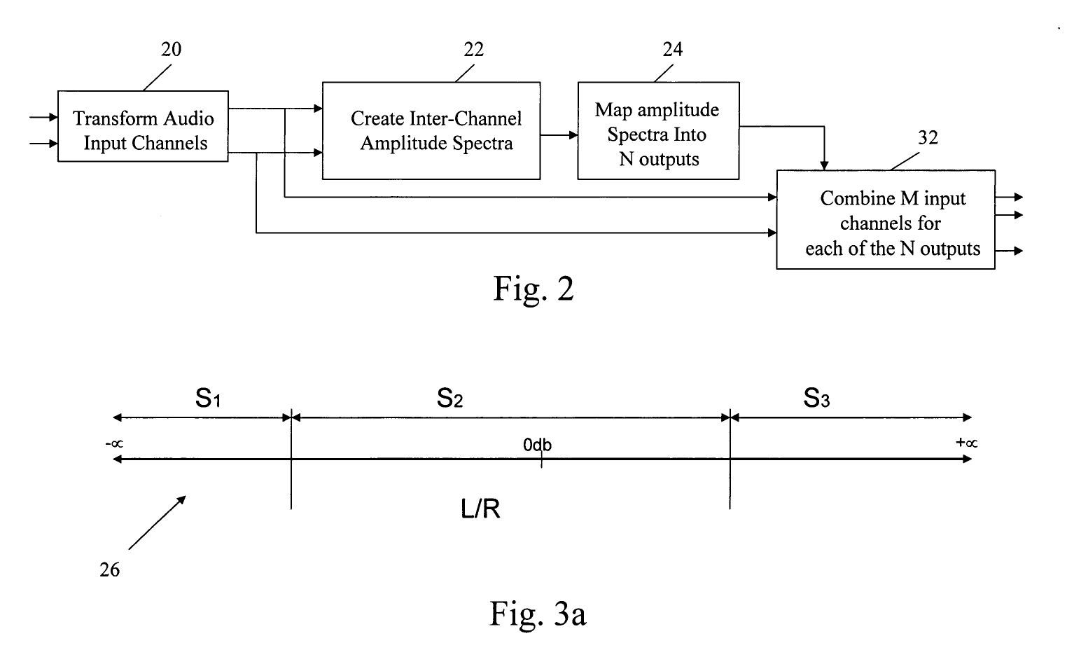

As shown in FIG. 2, the channel extractor implements an algorithm that uses inter-channel amplitude spectra. The channel extractor transforms each of the M, where M is at least two, audio input channels 10 into respective input spectra (step 20). The fast fourier transform (FFT) or DCT, MDCT or wavelet, for example, can be used to generate the frequency spectra. The channel extractor then creates at least one inter-channel amplitude spectra (step 22) from the input spectra for at least one pair of input channels. These inter-channel amplitude spectra may, for example, represent the linear, log or norm differences or summation of the spectral lines for pairs of input spectra. More specifically, if ‘A’ and ‘B’ are the amplitude of a spectral line for first and second channels, A−B is the linear difference, Log(A)−Log(B) is the log difference, (A²−B²) is the L2 norm difference and A+B is the summation. It is obvious to one of skill in the art that many other functions of A and B, f(A, B), can be used to compare the inter-channel amplitude relations of two channels.

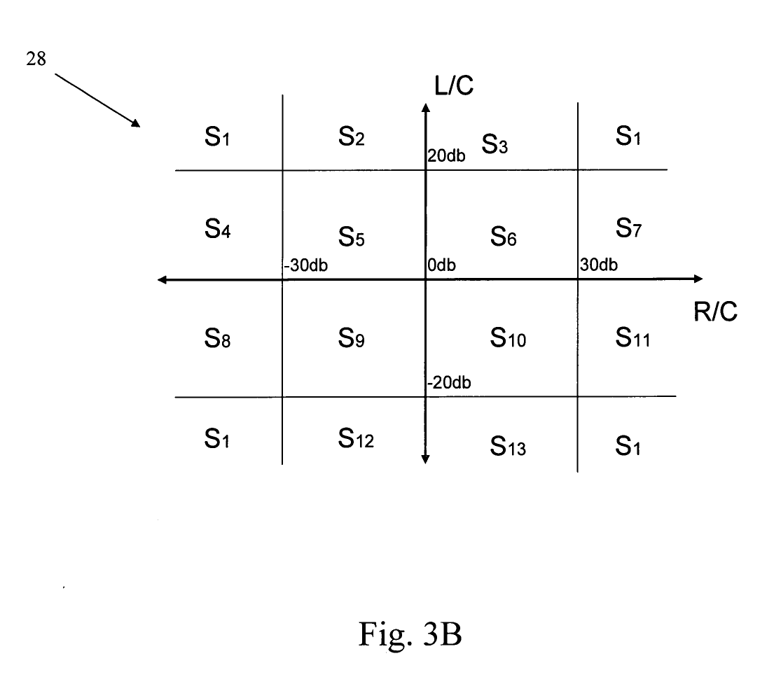

The channel extractor maps each spectral line for the inter-channel amplitude spectra into one of N defined outputs (step 24), suitably in an M−1 dimensional channel extraction space. As shown in FIG. 3a, the log difference for a pair (L/R) of input channels is thresholded at −3 db and +3 db to define outputs S₁(−∞,−3 db), S₂(−3 dB,+3 db) and S₃(+3 db,∞) in a one-dimensional space 26. If the amplitude of a particular spectral line is say 0 db it is mapped to output S₂ and so forth. The mapping is easily extended to N>3 by defining additional thresholds. As shown in FIG. 3b, three input channels L, R & C are mapped into thirteen output channels S₁, S₂ . . . S₁₃ in a two-dimensional channel extraction space 28. The log difference of L/C is plotted against the log difference of R/C and thresholded to define sixteen cells. In this particular example the extreme corner cells all map to the same output S₁. Other combinations of cells are possible depending on, for example, the desired number of outputs or any a priori knowledge of the sound field relationship of the input channels. For each spectral line, the amplitude of the log difference of R/C and L/C are mapped into the space and assigned the appropriate output. In this manner, each spectral line is only mapped to a single output. Alternately, the R/C and L/C inter-channel amplitude spectra could be thresholded separately in one-dimensional spaces as shown in FIG. 3a. An alternate mapping for the three input channels L, R & C into nine outputs in another two-dimensional channel extraction space 30 is depicted in FIG. 3c. These three examples are intended only to show that the inter-channel amplitude spectra may be mapped to the N outputs in many different ways and further that the principle extends to any number of input and output channels. Each spectral line may be mapped to a unique output in the M−1 dimensional extraction space.

Once each spectral line has been mapped to one of the N outputs, the channel extractor combines the data of the M input channels for each of the N outputs according to the mapping (step 32). For example, assume the case shown in FIG. 3a of stereo channels L & R mapped to outputs S1, S2 and S3 and further assume that an input spectrum has eight spectral lines. If, based on the inter-channel amplitude spectrum, lines 1-3 were mapped to S1, 4-6 to S2 and 7-8 to S2, the channel extractor would combine the input data for each of lines 1, 2 and 3 and direct that combined data to audio output channel one and so forth. In general, the input data are combined as a weighted average. The weights may be equal or vary. For example, if specific information was known regarding the sound field relationship of the input channels, e.g. L, R and C, it may effect selection of the weights. For example, if L>>R than you might choose weight the L channel more heavily in the combination. Furthermore, the weights may be the same for all of the outputs or may vary for the same or other reasons.

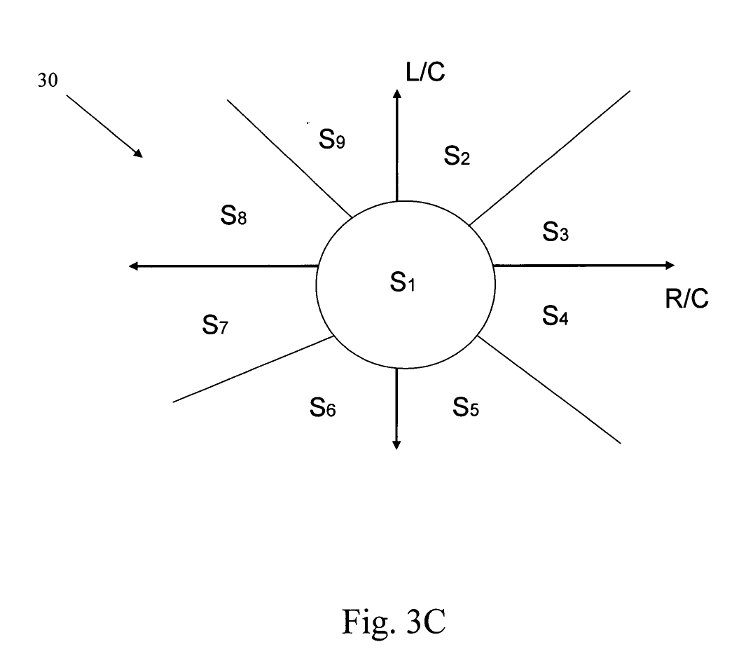

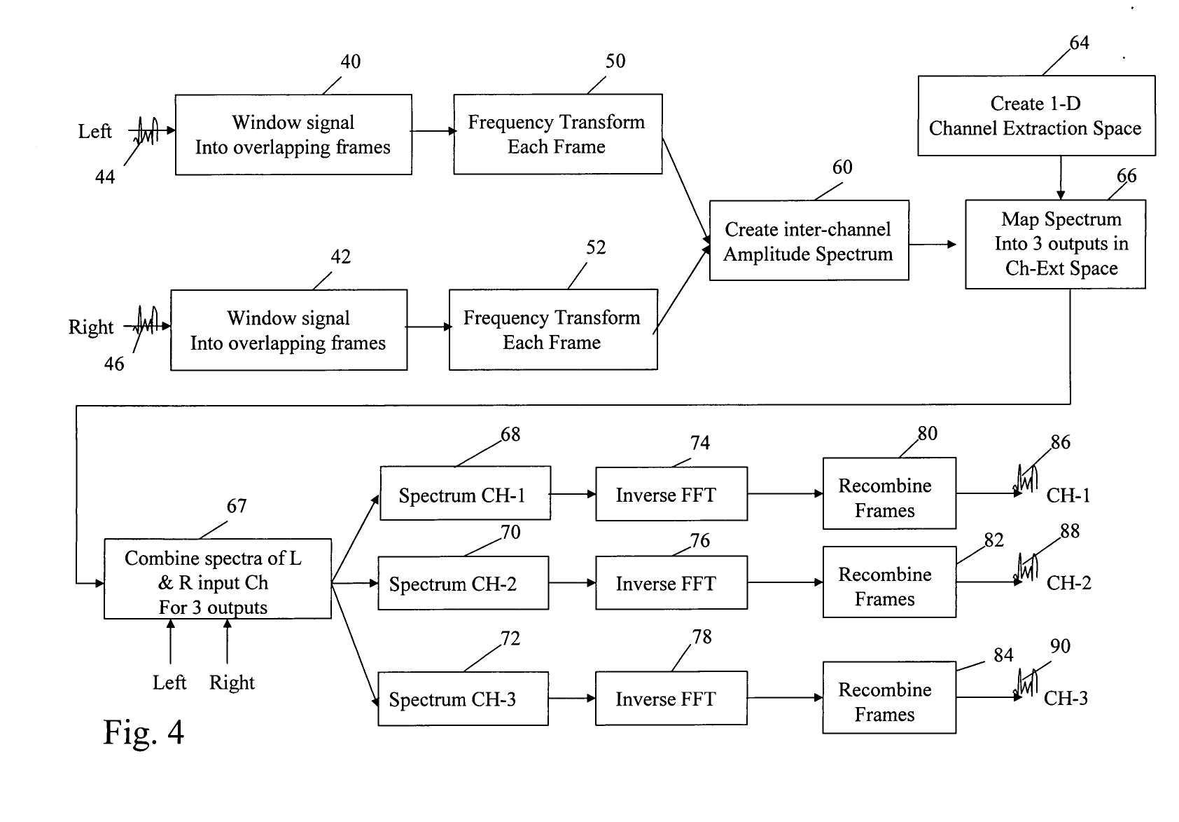

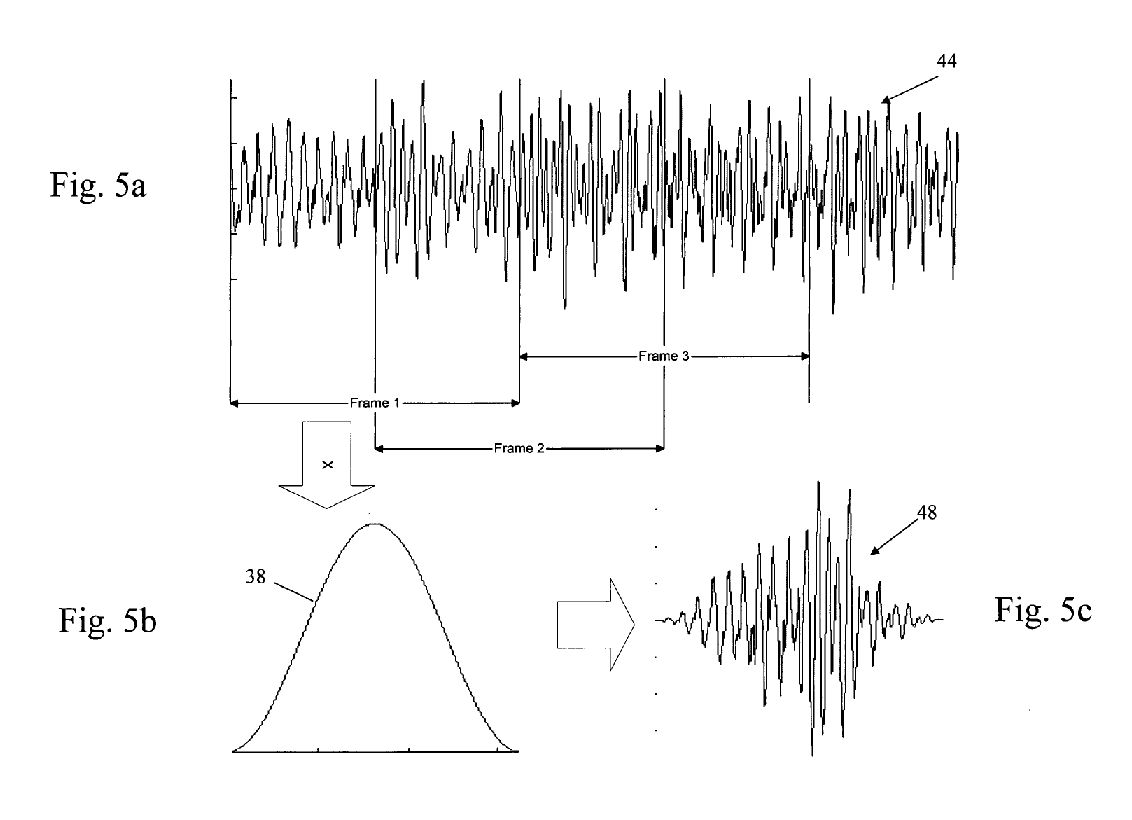

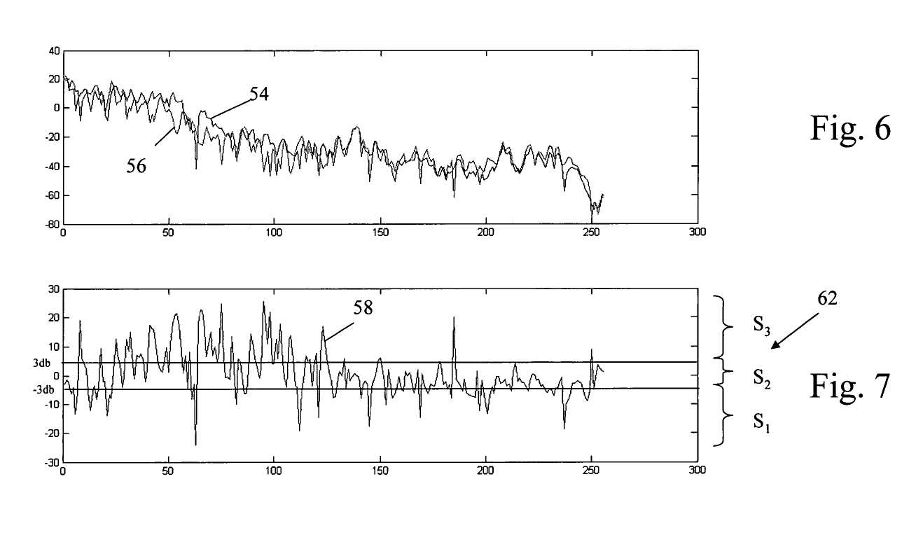

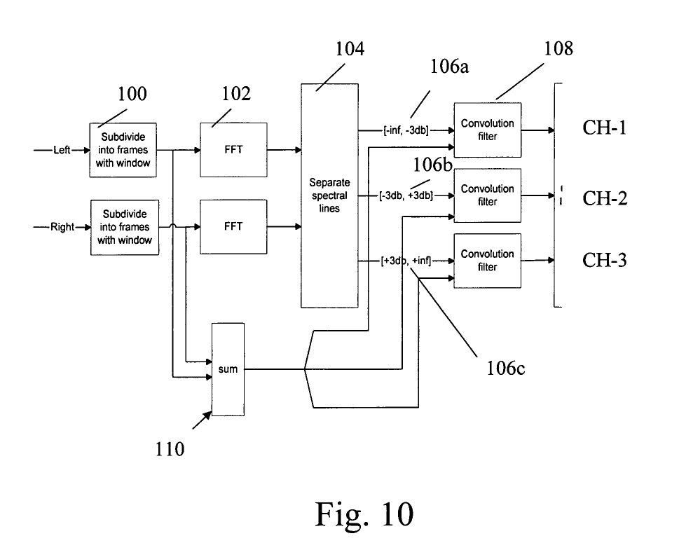

The input data may be combined using either frequency-domain or time-domain synthesis. As illustrated in FIGS. 4-9, the input spectra are combined according to the mappings and the combined spectra are inverse transformed and the frames recombined to form the N audio output channels. As illustrated in FIG. 10, a convolution filter is constructed for each of the N outputs using the corresponding spectral map. The input channels are passed through the N filters and recombined to form the N audio output channels.

FIGS. 4 through 10 illustrate in more detail an exemplary embodiment of the channel extraction algorithm for the case of extracting N=3 output channels from a stereo (M=2) pair of input channels. The channel extractor applies a window 38 e.g. raised cosine, Hamming or Hanning window (steps 40, 42) to the left and right audio input signals 44, 46 to create respective sequences of suitably overlapping frames 48 (left frame). Each frame is frequency transformed (step 50, 52) using an FFT to generate a left input spectrum 54 and right input spectrum 56. In this embodiment, the log difference of each spectral line of the input spectra 54, 56 is computed to create an inter-channel amplitude spectrum 58 (step 60). A 1-D channel extraction space 62, e.g. −3 db and +3 db thresholds, that bound outputs S1, S2 and S3, are defined (step 64) and each spectral line in the inter-channel amplitude spectrum 58 is mapped to the appropriate output (step 66).

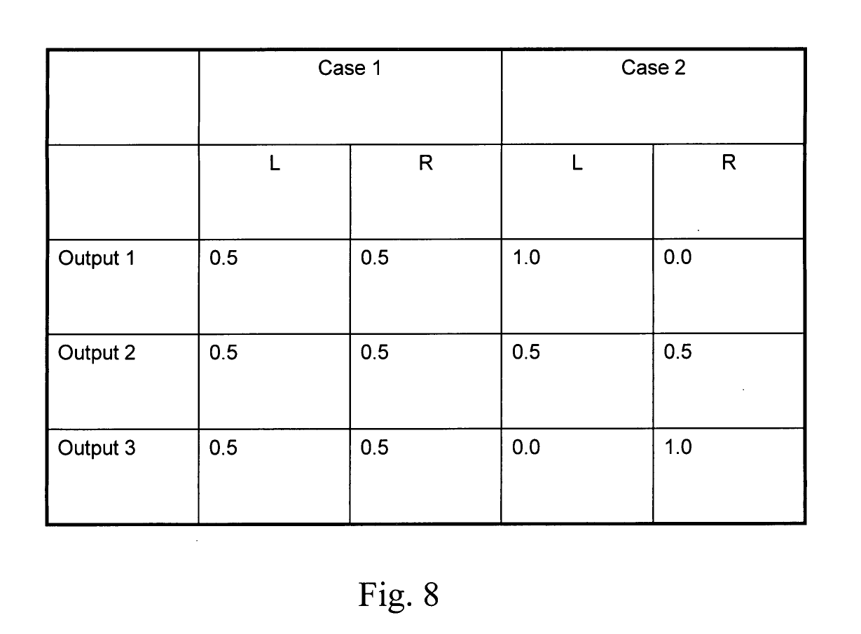

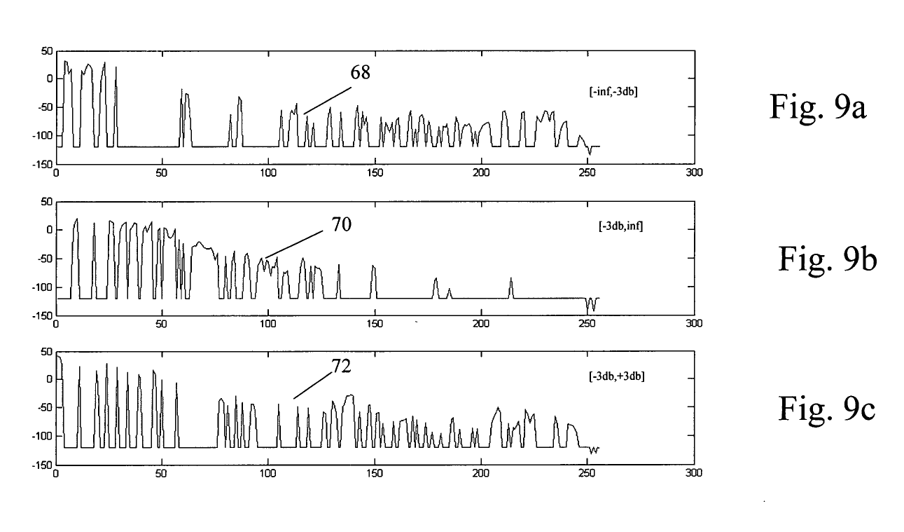

Once the mapping is completed, the channel extractor combines input spectra 54 and 56, e.g. amplitude coefficients of the spectral lines, for each of the three outputs in accordance with the mapping (step 67). As shown in FIGS. 8 and 9a-9c, in Case 1 the channels are equally weighted and the weights are the same to generate each audio output channel spectrum 68, 70 and 72. As depicted, for a given spectral line the input spectra are only combined for one output. In Case 2, perhaps having a priori knowledge of the L/R sound field, if the spectral line is mapped to Output 1 (L>>R) than only the L input channel is passed. If L and R are approximately equal they are weighted the same and if R>>L than only the R input channel is passed. The successive frames of each output spectrum are inverse transformed (steps 74, 76, 78) and the frames are recombined (steps 80, 82, 84) using a standard overlap-add reconstruction to generate the three audio output channels 86, 88 and 90.

FIG. 10 illustrates an alternate embodiment using time-domain synthesis for extracting the three audio output channels from the stereo pair in which the left and right input channels are subdivided into frames with a window such as a Hanning window (step 100), transformed using an FFT to form input spectra (step 102) and separated into spectral lines (step 104) by forming a difference spectrum and comparing each spectral line against thresholds (−3 db and +3 db) to construct three ‘maps’ 106a, 106b and 106c, one for each output channel. An element of the map is set to one if a spectral line difference falls into a correspondent category and to zero otherwise. These steps are equivalent to steps 40-66 illustrated in FIG. 4.

The input channels are passed through convolution filters constructed for each of the N outputs using the corresponding spectral maps and the M×N partial results are summed together and the frames recombined to form the N audio output channels (step 108). To reduce artifacts, a smoothing can be applied to maps prior to multiplication. Smoothing can be done with the following formula:

$${A}_{i}^{′} = \frac{{A}_{i - 1} + 2 \cdot {A}_{i} + {A}_{i + 1}}{4}$$

Other smoothing methods are possible. As it is depicted in the figure, summation (step 110) of the input channels can be done prior to filtering, if no weighting is required.

While several illustrative embodiments of the invention have been shown and described, numerous variations and alternate embodiments will occur to those skilled in the art. Such variations and alternate embodiments are contemplated, and can be made without departing from the spirit and scope of the invention as defined in the appended claims.

I claim:

1. A method of extracting N audio output channels from M<=N audio input channels, comprising:
transforming each of the M audio input channels into respective input spectra;
creating at least one inter-channel amplitude spectra from the input spectra for respective pairs of M audio input channels;
mapping each spectral line of the inter-channel amplitude spectra into one of N outputs; and
combining data from the M input channels according to the spectral mappings to form the N audio output channels.

2. The method of claim 1, wherein overlapping windows are applied to the audio input channels pre-transformation to form a sequence of frames and overlapping inverse windows are applied to the frames post-inverse transformation to recombine them into the N audio output channels.

3. The method of claim 1, wherein the inter-channel amplitude spectra are created as the linear, log or norm difference or summation of the input spectra.

4. The method of claim 1, wherein the spectral lines are mapped into an M−1 dimensional space in which the axes correspond to respective inter-channel amplitude spectra.

5. The method of claim 4, in which each spectral line is mapped to a single output.

6. The method of claim 1, wherein the spectral lines are thresholded to map them into one of the N outputs.

7. The method of claim 1, wherein the data from the input channels are combined as a weighted average.

8. The method of claim 7, wherein the weights are determined at least in part by a sound field relationship of the audio input channels.

9. The method of claim 1, wherein the data from the input channels is combined by,
combining the input spectra of the M input channels for each of the spectral lines mapped to each of the N outputs; and
inverse transforming each of the combined spectra to form the N audio output channels

10. The method of claim 1, wherein the data from the input channels is combined by,
constructing a filter for each of the N outputs using the corresponding map;
passing each of the M input channels through the N filters; and
combining the filter outputs to form N output channel frames.

11. The method of claim 1, wherein the N audio output channels are linearly independent

12. The method of claim 1, wherein the audio input channels comprise a mix of audio sources, further comprising using a source separation algorithm to separate the N audio output channels into an equal or lesser plurality of said audio sources.

13. A method of separating Q audio sources from M audio input channels comprising a mix of audio sources, comprising:
transforming each of the M audio input channels into respective input spectra;
creating at least one inter-channel amplitude spectra from the input spectra for respective pairs of M audio input channels;
mapping each spectral line of the inter-channel amplitude spectra into one of N≧Q outputs to create a map for each output;
combining data from the M input channels according to the maps to form the N audio output channels; and
using a source separation algorithm to separate the N audio output channels into Q audio sources.

14. The method of claim 13, wherein the N audio output channels are linearly independent.

15. A method of extracting N audio output channels from two audio input channels, comprising:
transforming each of the audio input channels into respective input spectra;
creating an inter-channel amplitude spectrum from the input spectra;
thresholding each spectral line of the inter-channel amplitude spectrum into one of N outputs; and
combining data from the M input channels according to the spectral mappings to form the N audio output channels.

16. The method of claim 15, wherein the inter-channel amplitude spectrum is created as the linear, log or norm difference or summation of the input spectra.

17. The method of claim 15, where the number N of audio output channels is three.

18. The method of claim 15, wherein the audio input channel are transformed using a fast fourier transform (FFT).

19. A channel extractor for extracting N audio output channels from M<=N audio input channels, comprising:
means for transforming each of the M audio input channels into respective input spectra;
means for creating at least one inter-channel amplitude spectra from the input spectra for respective pairs of M audio input channels;
means for mapping each spectral line of the inter-channel amplitude spectra into one of N outputs; and
means for combining data from the M input channels according to the spectral mappings to form the N audio output channels.

20. The channel extractor of claim 19, wherein the means for combining data comprises,
means for combining the input spectra of the M input channels for each of the spectral lines mapped to each of the N outputs; and
means for inverse transforming each of the combined spectra to form the N audio output channels

21. The channel extractor of claim 19, wherein the means for combining data comprises,
means for constructing a filter for each of the N outputs using the corresponding map;
means for passing each of the M input channels through the N filters; and
means for combining the filter outputs to form N output channel frames.
